(19) United States
(12) Patent Application Publication
(10) Pub. No.: US 2026/0197806 A1
(43) Pub. Date: Jul. 9, 2026

(54) METHOD AND APPARATUS FOR WIRELESS COMMUNICATION

(71) Applicant: QUECTEL WIRELESS SOLUTIONS CO., LTD., Shanghai (CN)

(72) Inventors: Ling LYU, Frisco, TX (US); Zheng ZHAO, Shanghai (CN)

(21) Appl. No.: 19/552,531

(22) Filed: Feb. 27, 2026

Related U.S. Application Data
(63) Continuation of application No. PCT/CN2024/089332, filed on Apr. 23, 2024.

(51) Int. Cl. H04W 72/0446; H04W 72/21

(52) U.S. Cl. CPC H04W 72/0446; H04W 72/21

(57) ABSTRACT

A method and apparatus for wireless communication are provided. One example method includes: obtaining, by a first device, a first sequence corresponding to a first uplink channel; and transmitting, by the first device, the first uplink channel based on the first sequence; wherein the first sequence is a sequence in a first sequence set, the first sequence set comprises a plurality of mutually orthogonal sequences, and the plurality of sequences corresponding to a plurality of time domain units in a first time domain unit group.

### CROSS-REFERENCE TO RELATED APPLICATIONS

This application is a continuation of International Application No. PCT/CN2024/089332, filed on Apr. 23, 2024, the disclosure of which is hereby incorporated by reference in its entirety.

### TECHNICAL FIELD

The present application relates to the field of communications technologies, and more particularly, to a method and apparatus for wireless communication.

### BACKGROUND

In an internet of things, because a transmit power is limited and a transmission path loss is large, a terminal device may improve the reliability of its uplink transmission through repetitive transmissions. However, in a communications system such as a non-terrestrial network (non-terrestrial network, NTN) system based on an internet of things, a quantity of available spectrums in a serving cell is limited, and a large quantity of terminal devices need to be served. In these communication scenarios, how to improve a system uplink capacity becomes an urgent technical problem that needs to be resolved.

### SUMMARY

The present application provides a method and apparatus for wireless communication. Various aspects of embodiments of the present application are described below.

According to a first aspect, a method for wireless communication is provided, including: determining, by a first device, a first sequence corresponding to a first uplink channel; and transmitting, by the first device, the first uplink channel based on the first sequence, where the first sequence is a sequence in a first sequence set, the first sequence set includes a plurality of mutually orthogonal sequences, and the plurality of sequences are determined based on a plurality of time domain units in a first time domain unit group.

According to a second aspect, a method for wireless communication is provided, including: receiving, by a second device, a first uplink channel that is transmitted by a first device based on a first sequence, where the first uplink channel corresponds to the first sequence, the first sequence is a sequence in a first sequence set, the first sequence set includes a plurality of mutually orthogonal sequences, and the plurality of sequences are determined based on a plurality of time domain units in a first time domain unit group.

According to a third aspect, an apparatus for wireless communication is provided, and the apparatus is a first device and includes: a determining unit, determining a first sequence corresponding to a first uplink channel; and a transmitting unit, transmitting the first uplink channel based on the first sequence, where the first sequence is a sequence in a first sequence set, the first sequence set includes a plurality of mutually orthogonal sequences, and the plurality of sequences are determined based on a plurality of time domain units in a first time domain unit group.

According to a fourth aspect, an apparatus for wireless communication is provided, and the apparatus is a second device and includes: a receiving unit, receiving a first uplink channel that is transmitted by a first device based on a first sequence, where the first uplink channel corresponds to the first sequence, the first sequence is a sequence in a first sequence set, the first sequence set includes a plurality of mutually orthogonal sequences, and the plurality of sequences are determined based on a plurality of time domain units in a first time domain unit group.

According to a fifth aspect, a communications apparatus is provided, including a memory and a processor, where the memory is configured to store a program, and the processor is configured to invoke the program in the memory to execute the method according to the first aspect or the second aspect.

According to a sixth aspect, an apparatus is provided, including a processor configured to invoke a program from a memory to execute the method according to the first aspect or the second aspect.

According to a seventh aspect, a chip is provided, including a processor configured to invoke a program from a memory, to cause a device on which the chip is installed to execute the method according to the first aspect or the second aspect.

According to an eighth aspect, a computer-readable storage medium is provided, where a program is stored on the computer-readable storage medium, and the program causes a computer to execute the method according to the first aspect or the second aspect.

According to a ninth aspect, a computer program product is provided, including a program, where the program causes a computer to execute the method according to the first aspect or the second aspect.

According to a tenth aspect, a computer program is provided, where the computer program causes a computer to execute the method according to the first aspect or the second aspect.

In embodiments of the present application, a first device may determine a plurality of mutually orthogonal sequences based on a plurality of time domain units in a first time domain unit group, so as to determine a first sequence corresponding to a first uplink channel. The plurality of mutually orthogonal sequences may be used by a plurality of devices including the first device to multiplex the plurality of time domain units. It can be learned that the plurality of devices may perform uplink transmission on a same resource by using the plurality of orthogonal sequences, thereby effectively enhancing an uplink capacity and improving spectrum utilization efficiency.

### BRIEF DESCRIPTION OF DRAWINGS

FIG. 1 shows a wireless communications system to which an embodiment of the present application is applied.

FIG. 2 shows an NTN system to which an embodiment of the present application is applied.

FIG. 3 shows another NTN system to which an embodiment of the present application is applied.

FIG. 4 is a schematic flowchart of a method for wireless communication according to an embodiment of the present application.

FIG. 5 is a schematic diagram of a possible implementation of the method shown in FIG. 4.

FIG. 6 is a schematic diagram of another possible implementation of the method shown in FIG. 4.

FIG. 7 is a schematic diagram of still another possible implementation of the method shown in FIG. 4.

FIG. 8 is a schematic diagram of yet another possible implementation of the method shown in FIG. 4.

FIG. 9 is a schematic structural diagram of an apparatus for wireless communication according to an embodiment of the present application.

FIG. 10 is a schematic structural diagram of another apparatus for wireless communication according to an embodiment of the present application.

FIG. 11 is a schematic structural diagram of a communications apparatus according to an embodiment of the present application.

### DESCRIPTION OF EMBODIMENTS

The following describes the technical solutions in embodiments of the present application with reference to the accompanying drawings for embodiments of the present application. Apparently, the described embodiments are some rather than all of embodiments of the present application. For embodiments of the present application, all other embodiments obtained by a person of ordinary skill in the art without creative efforts fall within the protection scope of the present application.

Embodiments of the present application may be applied to various communications systems. For example, embodiments of the present application may be applied to a global system for mobile communications (global system of mobile communication, GSM), a code division multiple access (code division multiple access, CDMA) system, a wideband code division multiple access (wideband code division multiple access, WCDMA) system, a general packet radio service (general packet radio service, GPRS) system, a long term evolution (long term evolution, LTE) system, an advanced long term evolution (advanced long term evolution, LTE-A) system, a new radio (new radio, NR) system, an evolved system of an NR system, an LTE-based access to unlicensed spectrum (LTE-based access to unlicensed spectrum, LTE-U) system, an NR-based access to unlicensed spectrum (NR-based access to unlicensed spectrum, NR-U) system, a universal mobile telecommunications system (universal mobile telecommunication system, UMTS), a wireless local area network (wireless local area networks, WLAN) system, a wireless fidelity (wireless fidelity, WiFi) system, and a 5th-generation (5th-generation, 5G) communication system. Embodiments of the present application may be further applied to another communications system, for example, a future communications system such as a 6th-generation (6th-generation, 6G) mobile communications system or a satellite (satellite) communications system.

Conventional communications systems support a limited quantity of connections and are easy to implement. However, with development of communications technologies, a communications system may support not only conventional cellular communication but also one or more other types of communication. For example, the communications system may support one or more types of the following communication: device-to-device (device to device, D2D) communication, machine-to-machine (machine to machine, M2M) communication, machine type communication (machine type communication, MTC), enhanced machine type communication (enhanced MTC, eMTC), vehicle-to-vehicle (vehicle to vehicle, V2V) communication, vehicle-to-everything (vehicle to everything, V2X) communication, or the like. Embodiments of the present application may also be applied to a communications system that supports the foregoing communication manners.

The communications system in embodiments of the present application may be applied to a carrier aggregation (carrier aggregation, CA) scenario, a dual connectivity (dual connectivity, DC) scenario, or a standalone (standalone, SA) networking scenario.

The communications system in embodiments of the present application may be applied to an unlicensed spectrum. The unlicensed spectrum may also be considered as a shared spectrum. Alternatively, the communications system in embodiments of the present application may be applied to a licensed spectrum. The licensed spectrum may also be considered as a dedicated spectrum.

Embodiments of the present application may be applied to an NTN system. As an example, the NTN system may be a 4G-based NTN system, an NR-based NTN system, an NTN system based on an internet of things (internet of things, IoT), or an NTN system based on a narrow band internet of things (narrow band internet of things, NB-IoT).

The communications system may include one or more terminal devices. The terminal device as mentioned in embodiments of the present application may also be referred to as user equipment (user equipment, UE), an access terminal, a subscriber unit, a subscriber station, a mobile site, a mobile station (mobile station, MS), a mobile terminal (mobile Terminal, MT), a remote station, a remote terminal, a mobile device, a user terminal, a terminal, a wireless communications device, a user agent, a user apparatus, or the like.

In some embodiments, the terminal device may be a station (STATION, ST) in a WLAN. In some embodiments, the terminal device may be a cellular phone, a cordless phone, a session initiation protocol (session initiation protocol, SIP) phone, a wireless local loop (wireless local loop, WLL) station, a personal digital assistant (personal digital assistant, PDA) device, a handheld device with a wireless communication function, a computing device or another processing device connected to a wireless modem, a vehicle-mounted device, a wearable device, a terminal device in a next-generation communications system (such as an NR system), a terminal device in a future evolved public land mobile network (public land mobile network, PLMN), or the like.

In some embodiments, the terminal device may be a device that provides a user with voice and/or data connectivity. For example, the terminal device may be a handheld device, a vehicle-mounted device, or the like that has a wireless connection function. In some specific examples, the terminal device may be a mobile phone (mobile phone), a tablet computer (Pad), a notebook computer, a palmtop computer, a mobile internet device (mobile internet device, MID), a wearable device, a virtual reality (virtual reality, VR) device, an augmented reality (augmented reality, AR) device, a wireless terminal in industrial control (industrial control), a wireless terminal in self-driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in smart home (smart home), or the like.

In some embodiments, the terminal device may be deployed on land. For example, the terminal device may be deployed indoors or outdoors. In some embodiments, the terminal device may be deployed on water, for example, on a ship. In some embodiments, the terminal device may be deployed in the air, for example, on an airplane, a balloon, and a satellite.

In addition to the terminal device, the communications system may further include one or more network devices. The network device in embodiments of the present application may be a device for communicating with the terminal device. The network device may also be referred to as an access network device or a wireless access network device. The network device may be, for example, a base station. The network device in embodiments of the present application may be a radio access network (radio access network, RAN) node (or device) that connects the terminal device to a wireless network. The base station may broadly cover various names below, or may be replaced with the following names, such as a NodeB (NodeB), an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master eNode (MeNB), a secondary eNode (SeNB), a multi-standard radio (MSR) node, a home base station, a network controller, an access node, a wireless node, an access point (access point, AP), a transmission node, a transceiver node, a baseband unit (base band unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), and a positioning node. The base station may be a macro base station, a micro base station, a relay node, a donor node, or the like, or a combination thereof. Alternatively, the base station may be a communications module, a modem, or a chip disposed in the device or apparatus described above. Alternatively, the base station may be a mobile switching center, a device that functions as a base station in D2D, V2X, or M2M communication, a network-side device in a 6G network, a device that functions as a base station in a future communications system, or the like. The base station may support networks with a same access technology or different access technologies. A specific technology and a specific device form used by the network device are not limited in embodiments of the present application.

The base station may be fixed or mobile. For example, a helicopter or an unmanned aerial vehicle may function as a mobile base station, and one or more cells may move based on a location of the mobile base station. In another example, a helicopter or an unmanned aerial vehicle may serve as a device that communicates with another base station.

In some deployments, the network device in embodiments of the present application may be a CU or a DU, or the network device includes a CU and a DU. The gNB may further include an AAU.

As an example rather than limitation, in embodiments of the present application, the network device may have a mobile characteristic, for example, the network device may be a movable device. In some embodiments of the present application, the network device may be a satellite or a balloon station. In some embodiments of the present application, the network device may alternatively be a base station arranged on land, water, or the like.

In embodiments of the present application, the network device may provide a service for a cell, and the terminal device communicates with the network device by using a transmission resource (for example, a frequency resource or a spectrum resource) used by the cell. The cell may be a cell corresponding to the network device (for example, a base station). The cell may belong to a macro base station or belong to a base station corresponding to a small cell (small cell). The small cell herein may include a metro cell (metro cell), a micro cell (micro cell), a pico cell (pico cell), a femto cell (femto cell), or the like. These small cells have a small coverage range and low transmit power, and are suitable for providing a high-rate data transmission service.

For example, FIG. 1 is a schematic diagram of an architecture of a communications system according to an embodiment of the present application. As shown in FIG. 1, a communications system 100 may include a network device 110, and the network device 110 may be a device that communicates with a terminal device 120 (or referred to as a communications terminal or a terminal). The network device 110 may provide communication coverage for a specific geographical region, and may communicate with a terminal device within the coverage.

FIG. 1 exemplarily shows one network device and two terminal devices. In some embodiments of the present application, the communications system 100 may include a plurality of network devices, and another quantity of terminal devices may be included within coverage of each network device. This is not limited herein.

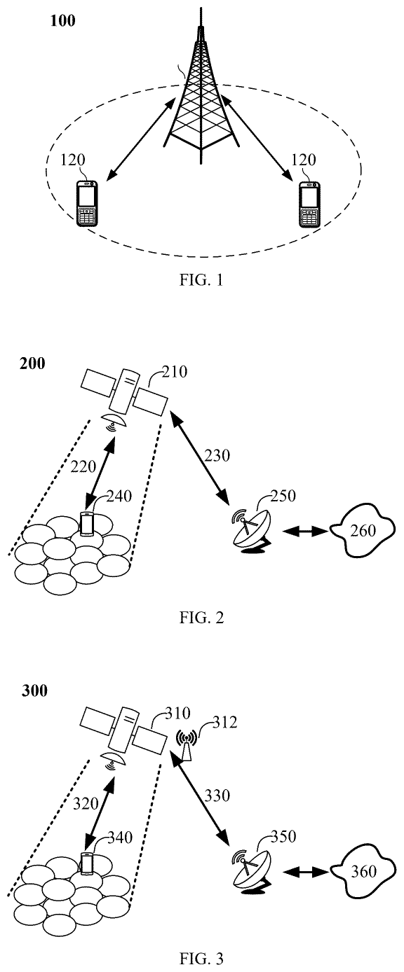

For example, FIG. 2 is a schematic diagram of an architecture of the NTN system mentioned above. An NTN system 200 shown in FIG. 2 uses a satellite 210 as an air platform. As shown in FIG. 2, a satellite radio access network includes the satellite 210, a service link 220, a feeder link 230, a terminal device 240, a gateway (gateway, GW) 250, and a network 260 including a base station and a core network.

The satellite 210 is a spacecraft based on a space platform. The service link 220 is a link between the satellite 210 and the terminal device 240. The feeder link 230 is a link between the gateway 250 and the satellite 210. The earth-based gateway 250 connects the satellite 210 to a base station or a core network, which specifically depends on a choice of the NTN architecture.

The NTN architecture shown in FIG. 2 is a bent-pipe transponder architecture. In this architecture, the base station is located on the earth behind the gateway 250, and the satellite 210 serves as a relay. The satellite 210 functions as a repeater for forwarding signals from the feeder link 230 to the service link 220, or forwarding signals from the service link 220 to the feeder link 230. In other words, the satellite 210 does not have a function of a base station, and communication between the terminal device 240 and the base station in the network 260 needs to be relayed by using the satellite 210.

For example, FIG. 3 is a schematic diagram of another architecture of the NTN system. As shown in FIG. 3, a satellite radio access network 300 includes a satellite 310, a service link 320, a feeder link 330, a terminal device 340, a gateway 350, and a network 360. Different from that in FIG. 2, a base station 312 is provided on the satellite 310, and the network 360 behind the gateway 350 includes only a core network.

The NTN architecture shown in FIG. 3 is a regenerative transponder architecture. In this architecture, the satellite 310 carries the base station 312, and may be directly connected to an earth-based core network through a link. The satellite 310 has a function of a base station, and the terminal device 340 may directly communicate with the satellite 310. Therefore, the satellite 310 may be referred to as a network device.

The communications systems in the architectures shown in FIG. 2 and FIG. 3 may include a plurality of network devices, and another quantity of terminal devices may be included within coverage of each network device. This is not limited in embodiments of the present application.

In embodiments of the present application, the communications systems shown in FIG. 1 to FIG. 3 may further include another network entity such as a mobility management entity (mobility management entity, MME) or an access and mobility management function (access and mobility management function, AMF). This is not limited in embodiments of the present application.

It should be understood that a device having a communication function in a network/system in embodiments of the present application may be referred to as a communications device. The communications system 100 shown in FIG. 1 is used as an example. The communications device may include a network device 110 and a terminal device 120 that have a communication function, and the network device 110 and the terminal device 120 may be specific devices described above. Details are not described herein again. The communications device may further include another device in the communications system 100, such as a network controller, a mobility management entity, and other network entities. This is not limited in embodiments of the present application.

For ease of understanding, some related technical knowledge related to embodiments of the present application is first introduced. The following related technologies, as optional solutions, may be arbitrarily combined with the technical solutions of embodiments of the present application, all of which fall within the protection scope of embodiments of the present application. Embodiments of the present application include at least a part of the following content.

### NTN

With development of communications technologies, communications systems (for example, 5G) will integrate market potential of satellites and terrestrial network infrastructure. For example, a 5G standard makes an NTN, including a satellite segment, to become a part of recognized 3rd generation partnership project (3rd generation partnership project, 3GPP) 5G connection infrastructure.

An NTN is a network or network segment that uses a radio frequency (radio frequency, RF) resource on a satellite platform or an unmanned aerial system (unmanned aerial system, UAS) platform. A satellite is used as an example. According to different orbital altitudes, communications satellites are classified into a low earth orbit (low earth orbit, LEO) satellite, a medium earth orbit (medium earth orbit, MEO) satellite, a geostationary earth orbit (geostationary earth orbit, GEO) satellite, a high elliptical orbit (high elliptical orbit, HEO) satellite, and the like. A LEO is an earth-centered orbit with a height of 2,000 km or less or at least 11.25 periods per day and an eccentricity less than 0.25. Most artificial objects in outer space are located on the LEO. A LEO satellite orbits around the earth at a high speed (mobile), but on a predictable or definite orbit.

Satellites with different orbital altitudes have different orbital periods. For example, a typical height of a LEO is 250-1500 km, and an orbital period is 90-120 minutes. A typical height of a MEO is 5000-25000 km, and an orbital period is 3-15 hours. A height of a GEO is about 35786 km, and an orbital period is 24 hours.

It may be learned from FIG. 2 and FIG. 3 in which a satellite is used as an example that, a typical scenario in which a terminal device accesses an NTN system relates to an NTN transparent payload (payload) or an NTN regenerative payload. The bent-pipe transponder architecture shown in FIG. 2 corresponds to the NTN transparent payload, and the regenerative transponder architecture shown in FIG. 3 corresponds to the NTN regenerative payload.

In the NTN system, a terminal device communicates with a network device by using a satellite-mounted or airborne platform. An air platform such as a satellite covers a relatively large area. Therefore, a quantity of terminal devices served in an NTN cell is generally far greater than that in a terrestrial network (terrestrial network, TN) cell. To meet uplink transmission of a terminal device in the cell, a requirement for uplink (uplink, UL) communication is generally relatively high.

### Internet of Things

A terminal device in an internet of things may perform wireless access or transmit uplink information and data by using a plurality of uplink channels. An NB-IoT is used as an example. A narrow band physical uplink shared channel (narrow-band physical uplink shared channel, NPUSCH) may be used to transmit uplink data. A narrow band physical uplink control channel (narrow-band physical uplink control channel, NPUCCH) may be used to transmit control information. A narrow band physical random access channel (narrow-band physical random access channel, NPRACH) may be used to perform access.

An uplink physical channel may support single-tone (single-tone) transmission and multi-tone (multi-tone) transmission. Single-tone transmission is also referred to as single frequency transmission, and multi-tone transmission is also referred to as multiple frequency transmission. For different subcarrier spacings (subcarrier spacing, SCS), single frequency transmission may include two transmission schemes: 3.75 kHz and 15 kHz single carrier frequency division multiple access (single carrier frequency division multiple access, SC-FDMA). Multiple frequency transmission may separately support 3 tones, 6 tones, and 12 tones based on 15 kHz. For example, when an uplink resource is a 180 kHz frequency band, if each sub-channel is 15 kHz, there are 12 sub-channels; and if each sub-channel is 3.75 kHz, there are 48 sub-channels.

In an example, when a subcarrier spacing is 3.75 kHz, one resource unit (resource unit, RU) includes one subcarrier in frequency domain, and includes 16 slots (slot) in time domain, and therefore, a length of one RU is 32 ms.

In an example, when a subcarrier spacing is 15 kHz, single frequency transmission and multiple frequency transmission are supported. When one RU includes one subcarrier and 16 slots, a length of the RU is 8 ms. When one RU includes 12 subcarriers, there is a time length of two slots, that is, 1 ms. This RU is exactly one subframe in an LTE system. A time length of an RU is generally designed as the power of 2, so that a resource can be more efficiently used, and resource waste caused by a resource vacancy can be avoided.

In an example, an NPUSCH may support single frequency transmission schemes of 3.75 kHz and 15 kHz and a multiple frequency transmission scheme of 15 kHz.

In an example, a 3.75 kHz SCS is generally configured for a terminal device at an edge of a cell in the internet of things. Due to longer duration and more repetitions (repetition) of a resource unit, UL transmission of the 3.75 kHz SCS usually takes more time than transmission of a 15 kHz SCS.

An NPUSCH format 1 is used as an example below to describe a resource occupied by an uplink channel. Transmission with the NPUSCH format 1 may be scheduled by a narrow band physical downlink control channel (narrow-band physical downlink control channel, NPDCCH) in a downlink control information (downlink control information, DCI) format N0. Alternatively, the transmission may further correspond to an uplink resource preconfigured by using a higher layer configuration parameter. For example, transmission performed by using a preconfigured uplink resource may be initiated by a higher layer, and retransmission of a transport block (transport block, TB) transmitted by using the preconfigured uplink resource is scheduled by the NPDCCH in the DCI format N0.

For example, a slot resource occupied by the NPUSCH format 1 may be N slots:

$$N = {N}_{TB} {N}_{rep} {N}_{R U} {N}_{slots}^{UL} ,$$

N_{TB} represents a quantity of scheduled TBs (for example, TBs scheduled in unicast), and is generally indicated by DCI, where if there is no DCI indication, N_{TB} is 1; Nᵣₑₚ represents a quantity of repetitions related to an uplink channel, and may be indicated by a repetition count field in the NPDCCH format N0 or configured by a higher layer for a preconfigured uplink; N_{RU} represents a quantity of RUs, and may be indicated by a resource allocation field in the NPDCCH format N0 or configured by using a higher-layer parameter used to preconfigure an uplink; and

$${N}_{slots}^{UL}$$

is a quantity of slots in one resource unit.

In related protocols, two parameters: Nₛₗₒₜₛ and

$${N}_{identical}^{NPUSCH}$$

are further introduced. After an NPUSCH is mapped to Nₛₗₒₜₛ slots, the Nₛₗₒₜₛ slots are repeated

$${N}_{identical}^{NPUSCH} - 1$$

times, to continue to map remaining data in subsequent slots. Nₛₗₒₜₛ is related to a subcarrier spacing, and

$${N}_{identical}^{NPUSCH}$$

is related to a transmission mode. For example, when the subcarrier spacing is 3.75 kHz, Nₛₗₒₜₛ=1, and when the subcarrier spacing is 15 kHz, Nₛₗₒₜₛ=2.

For an NPUSCH associated with a TB, the N UL slots are divided into

$${N}_{rep} / {N}_{identical}^{NPUSCH}$$

slot blocks. When N_{TB}=1, each slot block includes K consecutive slots:

$$K = {N}_{identical}^{NPUSCH} {N}_{RU} {N}_{slots}^{UL} .$$

When K consecutive slots are used for one redundancy version (redundancy version, RV), a plurality of redundancy versions are cycled among a plurality of slot blocks. Two redundancy versions (RV0 and RV2) are used as an example. RV0 and RV2 may be cycled among

$${N}_{rep} / {N}_{identical}^{NPUSCH}$$

slot blocks.

Terminal devices in the internet of things are diverse. The NB-IoT is still used as an example. Some NB-IoT devices may be mobile, and some NB-IoT devices are fixed. For example, the NB-IoT devices include a fixed-type device such as a gas meter and an electric meter.

In some examples, a transmit power of a terminal device in the internet of things is limited, and a path loss is relatively large when uplink transmission is performed by the terminal device. Due to a limited transmit power and a large path loss, a throughput of each terminal device is relatively low, and a capacity of an entire system is relatively low. Therefore, the terminal device generally repeatedly transmits uplink information and data a plurality of times, so as to improve reliability of uplink transmission.

Related technologies of the NTN and the internet of things are separately described above. It can be learned that both the internet of things and the NTN have relatively high requirements for uplink communication. In a communications system such as an NTN system based on an internet of things, a quantity of available spectrums in a serving cell is limited, and a large quantity of terminal devices need to be served in the serving cell. Therefore, impacts of a limited transmit power and a large path loss are more obvious. In other words, in these scenarios, how to improve a system uplink capacity becomes a technical problem that needs to be resolved.

It should be noted that the foregoing problem of a relatively high uplink capacity requirement of the internet of things-based NTN system is only an example. Embodiments of the present application may be applied to any communication scenario with high requirements for uplink communication. For example, a method in embodiments of the present application is also applicable to a TN network.

In a related technology, it is proposed that different terminal devices multiplex a same time/frequency resource by using an orthogonal cover code (orthogonal cover code, OCC), so as to increase a capacity/throughput of an uplink. The OCC is a technology that can implement resource multiplexing in a communications system. The OCC is a group of mutually orthogonal codewords, and a plurality of users can perform transmission on a same resource without mutual interference. Specifically, due to mutual orthogonality of orthogonal codes, superposed signals do not interfere with each other in time domain or frequency domain, thereby implementing multi-user resource multiplexing. At a receive end, a corresponding demodulation and decoding technology may be used to separate the superposed signals into raw data of each user.

To improve an uplink capacity, a solution of introducing an OCC into the internet of things-based NTN is already under discussion. In other words, in the internet of things-based NTN system, resource multiplexing may be implemented for a plurality of users based on an OCC, so that a same transmission resource can be shared. For example, a plurality of users may be distinguished by using different OCC sequences (also referred to as OCC codes), thereby occupying a same resource for transmission.

However, how to design an OCC sequence to improve a system uplink capacity is an important technical problem. For example, a plurality of devices perform transmission based on a slot-level OCC, and when each device uses a specific OCC, if devices multiplexing a same resource perform transmission at the same time, mutual interference may be caused. The mutual interference may damage orthogonality of OCCs. Therefore, an appropriate OCC code length needs to be designed for different scenarios, and a proper modulation and coding scheme (modulation and coding scheme, MCS) needs to be selected.

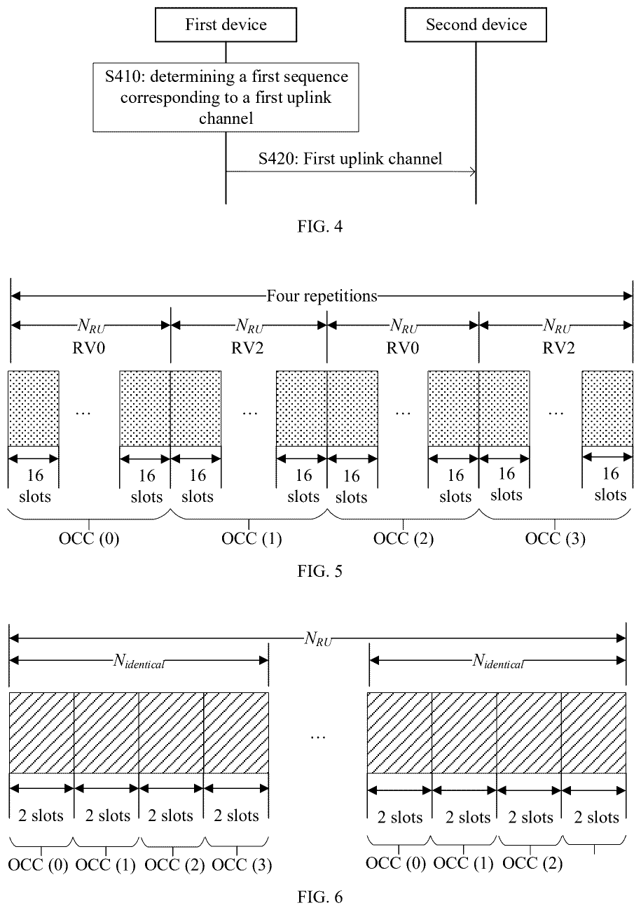

To resolve the foregoing problem, embodiments of the present application provide a method for wireless communication. In this method, a first device may determine, based on a time domain unit in a time domain unit group, a first sequence corresponding to a to-be-transmitted first uplink channel. A plurality of devices may separately transmit uplink channels based on a plurality of mutually orthogonal sequences, thereby multiplexing time domain unit groups associated with the plurality of sequences. For ease of understanding, the following describes in detail the method provided in embodiments of the present application with reference to FIG. 4. FIG. 4 is described from a perspective of interaction between a first device and a second device.

Referring to FIG. 4, in step S410, the first device determines a first sequence corresponding to a first uplink channel.

The first device may be any type of terminal device or repeater that performs uplink transmission, which is not limited herein. In some embodiments, the first terminal device may be any terminal device in an NTN system, for example, UE. In some embodiments, the first terminal device may be any terminal device in an NB-IoT system, for example, an electric meter.

In an embodiment, the first device is located in coverage of an NTN satellite. For example, the first device is a terminal in an internet of things-based NTN.

In an embodiment, the first device is a communications device that performs uplink transmission to a device on a network side in any communications system.

The second device may be any network device or device on a network side described above. In some embodiments, the second device includes a satellite in the NTN system, and the first device is a terminal device that performs communication by using the satellite. For example, when a base station is deployed on the satellite, the first device directly communicates with the base station on the satellite. For example, when the satellite serves as a relay, the first device communicates, by using the satellite, with a network device located on the ground. In an embodiment, when the second device includes a satellite, the first device is located in a service area of the satellite at a current instant, so as to perform uplink transmission to the second device by using the satellite.

In some embodiments, the first device may be any device in a plurality of devices multiplexing a same resource. The plurality of devices multiplexing the same resource may form a device set. One or more devices multiplexing the same resource as the first device may also be referred to as a pairing device of the first device.

In an example, the same resource multiplexed by the plurality of devices may be a time/frequency resource, or may be a time-frequency resource.

In some embodiments, the same multiplexed resource may be one or more time domain units. Optionally, the same multiplexed resource includes a plurality of time domain units in a first time domain unit group. In an example, a plurality of devices including the first device respectively correspond to a plurality of uplink channels including the first uplink channel. The plurality of uplink channels are transmitted by multiplexing the plurality of time domain units.

In an example, the resource multiplexed by the plurality of devices may include a first time resource. The first time resource is used to transmit a plurality of uplink channels.

Optionally, a system may group uplink channel resources (for example, time units), so that the first device determines a first sequence set.

In some embodiments, the plurality of uplink channels may include an uplink shared channel, an uplink control channel, or a random access channel, which is not limited herein. In an example, the first uplink channel may be one or more of an NPUSCH, an NPRACH, or an NPUCCH.

In some embodiments, transmission of the first uplink channel is related to orthogonality of a plurality of sequences. An NPUSCH format 1 is used as an example, and considering a resource allocation manner and a repetitive transmission solution of the NPUSCH format 1, power consistency and phase continuity of repeated signals need to be maintained, so that orthogonality of a plurality of sequences can be maintained.

In some embodiments, a time-frequency resource on which the first uplink channel is located may further include a demodulation reference signal (demodulation reference signal, DMRS). The DMRS may be used to perform channel estimation and coherent demodulation on an uplink channel transmitted by a terminal device.

In an example, when different quantities of subcarriers are included in each of RUs, different DMRSs may be correspondingly generated. When each RU includes one subcarrier, sequence group hopping in each slot in the RU is consistent. When each RU includes a plurality of subcarriers, a calculation manner of a sequence group changes once every even number of slots in the RU, so as to ensure that each subcarrier in each slot in the RU includes at least one reference signal, thereby ensuring that each subcarrier can be correctly demodulated.

In an example, there may be a DMRS in a slot for transmitting an NPUSCH. For a DMRS mode of the NPUSCH format 1, there is only one DMRS symbol on each subcarrier in each slot. The DMRS symbol may also be referred to as a reference symbol in a slot. For example, when a subcarrier spacing is 3.75 kHz, the DMRS is located in a fifth symbol of each slot. For example, when a subcarrier spacing is 15 kHz, the DMRS is located in a fourth symbol of each slot.

The first sequence may be a sequence in the first sequence set that corresponds to the first uplink channel of the first device. The first sequence set includes a plurality of mutually orthogonal sequences. In other words, the plurality of sequences in the first sequence set are a group of orthogonal codes, which may also be referred to as an orthogonal sequence set.

In some embodiments, the plurality of sequences in the first sequence set are a group of OCC sequences, and the first sequence is a first OCC sequence. In an example, the plurality of sequences in the first sequence set are a group of orthogonal codes selected from an available OCC set, and each sequence is also referred to as an OCC orthogonal code. For example, the first sequence whose length is 4 may be represented as an OCC (0), an OCC (1), an OCC (2), and an OCC (3).

Optionally, the first sequence set may use a Zadoff-Chu (ZC) sequence as an orthogonal code. The ZC sequence is a sequence with good orthogonality. Specifically, the ZC sequence may obtain different orthogonal codes by selecting different root indexes and sequence lengths.

Optionally, the first sequence set may use a Hadamard (Hadamard) matrix as an orthogonal code. The Hadamard matrix is a special orthogonal matrix, all rows of which are mutually orthogonal. In embodiments of the present application, a row of the Hadamard matrix may be used as an orthogonal cover code. Such a codeword set may ensure good orthogonality in time domain/frequency domain. In this way, multi-user resource multiplexing is also implemented.

Optionally, the first sequence set may use comb-like orthogonal codes, so that the plurality of sequences have fixed intervals. For example, the plurality of sequences may have a fixed time interval, that is, equal intervals in time domain. By using an equal interval design in time domain, it can be ensured that mutual interference between orthogonal codes used in different time domain units is as small as possible, thereby improving system performance.

Optionally, the plurality of sequences in the first sequence set may be orthogonal in frequency domain or time domain, which is not limited herein.

In some embodiments, the plurality of sequences in the first sequence set may be respectively used for the plurality of devices including the first device, so as to implement multiplexing. For example, a quantity of the plurality of sequences in the first sequence set is equal to a quantity of devices multiplexing the plurality of time domain units in the first time domain unit group.

In some embodiments, a length of the first sequence may represent a quantity of elements in the first sequence, which is also a quantity of codewords, that is, a code length. For example, the code length of the first sequence is 4, which indicates that there are four codewords: W₀, W₁, W₂, and W₃. For another example, the code length of the first sequence is 2, which indicates that there are only two codewords: W₀ and W₁. When the first sequence is an OCC sequence, W₀ is the OCC(0) described above.

In some embodiments, the length of the first sequence may be related to a plurality of parameters. The plurality of parameters may be related to a transmission resource and/or a transmission mode of the first uplink channel, so as to implement resource multiplexing. As described above, the transmission resource of the first uplink channel may be the first time resource, and the first time resource may include one or more time domain units in the first time domain unit group. For example, the length of the first sequence may be determined based on a quantity of time domain units in the first time domain unit group and/or a quantity of repetitions of the first uplink channel.

In an example, the length of the first sequence may be determined based on a quantity of time domain units. For example, the length of the first sequence may be equal to the quantity of time domain units in the first time domain unit group. For another example, the quantity of time domain units may be an integer multiple of the length of the first sequence.

In an example, the length of the first sequence may be determined based on the quantity of repetitions of the first uplink channel. The quantity of repetitions of the first uplink channel may be Nᵣₑₚ described above. When the first uplink channel is an NPUSCH, the length of the first sequence may also be

$${N}_{identical}^{NPUSCH} .$$

For example, the quantity of repetitions of the first uplink channel may be equal to the length of the first sequence.

In an example, when the first sequence set is a group of OCC sequences, the first sequence may be a sequence W=[wᵢ(0), wᵢ(1), . . . wᵢ(m)], where i represents an index of the first sequence, and m=0, 1, . . . , Nᵣₑₚ−1.

In an example, the length of the first sequence may be determined based on a size of an RV, so as to match a transmission resource of an uplink channel.

In some embodiments, a span of the first sequence in time domain needs to be as small as possible, so as to maintain orthogonality of a plurality of sequences.

The plurality of sequences in the first sequence set are determined based on the plurality of time domain units in the first time domain unit group. The plurality of sequences in the first sequence set are used to multiplex the plurality of time domain units in the first time domain unit group. Therefore, the plurality of sequences may be determined based on the plurality of time domain units. When the plurality of sequences in the first sequence set are a group of OCC sequences, the sequences may also be referred to as time domain OCCs or group-level OCCs.

In an example, the first device may select, from an OCC set, a plurality of mutually orthogonal OCC sequences based on the plurality of time domain units in the first time domain unit group, to form the first sequence set. For example, the quantity of the plurality of time domain units may be used to determine the length of the plurality of sequences.

In an example, the plurality of time domain units in the first time domain unit group are respectively combined with the plurality of sequences in the first sequence set, so as to perform spectrum spreading on the plurality of time domain units, so that the plurality of sequences are in one-to-one correspondence with the plurality of devices in a case that orthogonality is met.

In an example, the first time domain unit group may include a plurality of time domain unit subgroups, and a plurality of mutually orthogonal sequences may be separately combined with each time domain unit subgroup, so as to implement multiplexing of each time domain unit subgroup by means of spectrum spreading.

Optionally, any one of the plurality of sequences may be cyclically applied to the plurality of time domain units in the first time domain unit group. For example, for multiple frequency transmission, when Nᵣₑₚ≥8, an OCC sequence whose length is 4 may be repeatedly applied every

$${N}_{slot}^{UL} \cdot {N}_{identical}^{NPUSCH}$$

slots, and description is provided below with reference to FIG. 6.

In some embodiments, the plurality of time domain units in the first time domain unit group may be a plurality of time domain units with the same time length, or may be a plurality of time domain units in which some time domain units have the same time length, or a plurality of time domain units with different time lengths, which is not limited herein.

In some implementations, a time length of each of the plurality of time domain units may be based on one or more symbols, one or more slots, or one or more RUs or RVs. In an example, when an OCC is applied to uplink channel transmission, there may be a plurality of modes such as an intra-symbol mode, an inter-symbol mode, or an inter-slot mode. For example, a time domain OCC may be an OCC based on a symbol or a slot. For a symbol-based OCC technology, an OCC sequence may be multiplied by each symbol. At a receive end, the OCC may be removed to recover personal data for each user. For a slot-based OCC technology, an OCC sequence may be multiplied by a related slot. It should be noted that, when the related slot is multiplied by the OCC sequence, a reference symbol in the slot may or may not be included. Example description is provided below with reference to generation of a sequence corresponding to a DMRS.

In an example, a time length of each time domain unit in the first time domain unit group may be fixed, or may be adjusted dynamically.

In some embodiments, the first time domain unit group used to determine the first sequence set may be one of a plurality of time domain unit groups. The plurality of time domain unit groups may respectively correspond to time domain units with different time lengths. In other words, a system (for example, a base station) may configure a plurality of time domain unit groups for transmission of the first uplink channel or a plurality of uplink channels, so that a time length of a time domain unit in the first time domain unit group corresponding to the first sequence set is adjusted in time based on an actual communication condition. It can be learned that the first time domain unit group may be adjusted dynamically.

In an example, a time domain OCC may be extended to a symbol-level or slot-level OCC, and applied to transmission of a plurality of uplink channels.

In some embodiments, the plurality of time domain unit groups may be determined based on a plurality of grouping manners of the first time resource. The plurality of grouping manners include a plurality of grouping granularities. For example, the plurality of time domain unit groups may be determined after grouping is performed on the first time resource based on different time lengths. In an example, grouping information of the plurality of time domain unit groups may be delivered by using DCI, or may be provided based on information of a system information block (system information block, SIB). In other words, the grouping information of the plurality of time domain unit groups is carried in the DCI or SIB.

In an example, the grouping information may include levels and/or time domain unit lengths of the plurality of time domain unit groups, which is not limited herein.

In an example, a grouping manner of the plurality of time domain unit groups may be fixed, or may be adjusted dynamically, which is not limited herein.

In some embodiments, the plurality of time domain unit groups respectively correspond to a plurality of different time domain unit lengths, and the plurality of different time domain unit lengths are used to determine the first time domain unit group in the plurality of time domain unit groups. In other words, the first device or the second device may select the first time domain unit group from the plurality of time domain unit groups based on an actual communication condition.

In some embodiments, a time domain unit length of the first time domain unit group is not fixed, but may be adjusted dynamically. For example, the first time domain unit group corresponds to a first time domain unit length at a first instant, and the first time domain unit group corresponds to a second time domain unit length at a second instant adjacent to the first instant. For example, the first instant is earlier than the second instant, and the first time domain unit length is greater than or less than the second time domain unit length.

In an example, when grouping of the plurality of time domain unit groups or the time domain unit length of the first time domain unit group is adjusted dynamically, the length of the first sequence may be adjusted as the grouping or the time domain unit length is adjusted dynamically.

In some embodiments, the plurality of time domain unit groups may be sorted sequentially based on a time length of a time domain unit, so that the first time domain unit group can be selected and adjusted dynamically. The time length of the time domain unit may also be referred to as a time domain unit length. For example, the plurality of time domain unit groups may correspond to a plurality of classes of groups. In other words, a plurality of time domain unit groups determined based on a plurality of group time lengths respectively correspond to different levels, which may also be referred to as classes. A system may adjust the first time domain unit group in a downgrading or upgrading manner based on an actual communication condition.

In an example, the plurality of time domain unit groups may include the first time domain unit group and a second time domain unit group. The time domain unit length of the first time domain unit group is different from a time domain unit length of the second time domain unit group.

In an example, when the time domain unit length of the first time domain unit group is greater than the time domain unit length of the second time domain unit group, a level of the first time domain unit group is higher than a level of the second time domain unit group, or when the time domain unit length of the first time domain unit group is less than the time domain unit length of the second time domain unit group, a level of the first time domain unit group is higher than a level of the second time domain unit group.

In an example, when the time domain unit length of the first time domain unit group is greater than the time domain unit length of the second time domain unit group, a level of the first time domain unit group is lower than a level of the second time domain unit group, or when the time domain unit length of the first time domain unit group is less than the time domain unit length of the second time domain unit group, a level of the first time domain unit group is lower than a level of the second time domain unit group.

In some embodiments, the plurality of grouping manners described above may be determined based on a part of or all of the following time lengths: all slots in different redundancy versions (RV); all slots in one redundancy version; some slots in one redundancy version; all slots in one resource unit (RU); one slot; and one or more symbols in one slot.

In an example, any one or more of the time lengths described above may be used as a division boundary of any time domain unit group.

In some embodiments, the plurality of time domain unit groups may be a plurality of groups determined based on one time domain unit. For example, when the plurality of time domain unit groups are obtained by means of grouping performed based on a slot, a time domain unit length in each time domain unit group is related to a slot, that is, the time domain unit length is determined based on the slot. The plurality of time domain unit groups determined based on the slot may also be referred to as slot groups.

Taking uplink transmission of an NPUSCH as an example, slot grouping may be performed based on the following principles.
Group 1: grouping is performed across slots. Optionally, a quantity of slots in grouping across slots may be greater than a quantity of slots in one RV.
Group 2: all slots in one RV is a group. Optionally, a quantity of slots in an RV is related to a transmission mode of an uplink channel.
Group 3:

$${N}_{identical}^{NPUSCH}$$

slots in one RV is a group. Optionally, a quantity of some slots in one RV may be another value.
Group 4: all slots in one RU is a group. In other words, a time length of one time domain unit is determined based on a quantity of slots in one RU.
Group 5: one slot is a group. In other words, one slot is used as one time domain unit.

It can be learned from Group 1 to Group 5 that a time domain unit length of each group is gradually decreased. Time domain grouping is used by a plurality of devices for transmitting uplink channels, and when Group 1 is replaced with Group 2, a quantity of a plurality of devices corresponding to the time domain unit groups may change, and therefore the time domain grouping is also referred to as device grouping.

In some embodiments, the plurality of time domain unit groups may be a plurality of groups determined based on a plurality of time domain units. For example, the plurality of time domain unit groups may be obtained by means of grouping performed based on a slot, a symbol, and another time domain unit. Because the time length of a slot is greater than that of a symbol, the plurality of time domain unit groups may include a plurality of slot groups and a plurality of symbol groups. Symbol grouping refers to that a length of each time domain unit is determined based on a symbol.

For example, in addition to the plurality of slot groups in Group 1 to Group 5, the plurality of time domain unit groups may further include a plurality of symbol groups below.
Group 6: a plurality of symbols in one slot is a group. Optionally, the plurality of symbols may be determined based on to-be-transmitted information or data.
Group 7: one symbol is a group. In other words, one symbol is used as one time domain unit.

In some embodiments, “determining a first sequence corresponding to a first uplink channel” may also be replaced with “determining a first OCC sequence used for transmitting a first uplink channel” or “determining a first sequence related to a first uplink channel”. In an example, the first device may determine the first sequence by using a transmission resource (for example, the first time resource) of the first uplink channel. In an example, the first device may determine the first time domain unit group, and determine a length of each time domain unit based on the first time domain unit group. Further, the first device may determine, based on a length of time domain units or a quantity of time domain units, the first sequence corresponding to the first device in the first sequence set.

In some embodiments, the first time domain unit group may be indicated by a network device, or may be independently selected by the first device. For example, the network device (for example, a base station) may dynamically adjust the first time domain unit group based on a communication condition.

In an example, the network device may dynamically adjust the first time domain unit group based on feedbacks from a plurality of devices including the first device. Because the plurality of devices multiplex a same resource, if most of the plurality of devices feed back a poor transmission effect, it indicates that a division granularity of time domain unit groups is relatively large, and a length of a time domain unit may be reduced, thereby improving transmission efficiency. It can be learned that the first time domain unit group may be determined based on a plurality of feedbacks from a plurality of devices. Optionally, the plurality of feedbacks transmitted by the plurality of devices may include an acknowledgement (acknowledgement, ACK) and a negative acknowledgement (negative acknowledgement, NACK). For example, the feedbacks of the plurality of devices are hybrid automatic repeat request (hybrid automatic repeat reQuest, HARQ) feedbacks.

In an example, the network device may determine, based on a feedback obtained at a second instant, the first time domain unit group at a first instant. The second instant is earlier than the first instant, and the second instant is adjacent to the first instant, which is beneficial to perform adjustment in time. For example, when the first device transmits the first uplink channel based on the first sequence at the first instant, the first time domain unit group may be determined based on the plurality of feedbacks transmitted by the plurality of devices at the second instant.

In an example, if a quantity of NACKs in the plurality of feedbacks transmitted by the plurality of devices is greater than or equal to a first threshold, the time domain unit length of the first time domain unit group is less than a time domain unit length of a third time domain unit group, and the third time domain unit group is associated with a feedback transmitted by the first device at the second instant. In other words, if most of the devices feed back NACKs, a time length of a time domain unit is reduced.

Optionally, the first threshold may be equal to a total quantity of the plurality of devices multiplexing the same resource, or may be any value less than the total quantity.

The five slot groups described above are used as an example. After the base station continuously receives HARQs from a plurality of UEs multiplexing a same resource, the base station may flexibly adjust a size of the first time domain unit group. If a plurality of UEs transmit NACKs, the base stations may downgrade the group from Group 1 to Group 2. In contrast, if the base station continuously receives ACKs transmitted by a plurality of UEs, the base station may upgrade the first time domain unit group, for example, upgrading the first time domain unit group from Group 5 to Group 4, from Group 4 to Group 3, from Group 3 to Group 2, or from Group 2 to Group 1.

In an example, downgrading or upgrading of the first time domain unit group may be performed level by level, to save resources. For example, instead of adjustment performed across levels, downgrading may be performed from Group 1 to Group 2, from Group 2 to Group 3, from Group 3 to Group 4, or from Group 4 to Group 5.

In an example, downgrading or upgrading of the first time domain unit group may also be performed across levels, to improve transmission efficiency more quickly.

Still referring to FIG. 4, in step S420, the first device transmits the first uplink channel to the second device. The second device may be any network device or device on a network side described above, or may be any communications device that implements a connection between the first device and a network device. For example, the second device may be a base station. For another example, the second device is a satellite on which a base station is deployed, or a satellite that can communicate with a ground-based base station.

In some embodiments, the second device is any network device or device on a network side in an internet of things-based NTN.

The first device may transmit the first uplink channel based on the first sequence. In other words, when the first device transmits the first uplink channel, it is necessary to consider the first sequence. The first device may determine, based on to-be-transmitted data of the first uplink channel and the first sequence, data or a sequence that needs to be actually transmitted. In other words, the to-be-transmitted data of the first uplink channel may be transmitted after spectrum spreading is performed on the data by using the first sequence. Therefore, transmission of a result obtained after the spectrum spreading may be equivalent to transmission of the first uplink channel. After processing the result, the receive end may obtain the data in the first uplink channel.

In an example, the result obtained after the spectrum spreading may include data and/or a sequence. The first device may transmit the result by using a time-frequency resource. For example, when the first uplink channel is an NPUSCH, spectrum spreading may be performed on data of the NPUSCH by using an element (for example, W₀ and W₁) of the first sequence, to obtain data and/or a sequence after the spectrum spreading.

Optionally, the to-be-transmitted data of the first uplink channel may include raw data, or may include a modulation signal obtained after data processing.

Optionally, the first device may process the to-be-transmitted data, and after a modulation signal is obtained, spectrum spreading processing is performed on the modulation signal based on the first sequence.

Optionally, a sequence obtained after the spectrum spreading may be a Walsh sequence or a discrete fourier transform (discrete fourier transform, DFT) sequence.

In an example, the first device may multiply the first sequence and the modulation signal of the first uplink channel, to obtain data input or a sequence. For example, the first uplink channel is an NPRACH, and when a group-level OCC is considered for the NPRACH, each symbol group may be multiplied by one OCC. An OCC sequence may be multiplied by four or six symbol groups in different subcarriers. In a symbol group, all symbols are multiplied by a same code. All symbol groups in a preamble format are transmitted in different subcarriers with frequency hopping, and two adjacent symbol groups may be multiplied by different OCC codes.

For example, for an inter-slot OCC, an OCC sequence is applied to a plurality of slots. The plurality of slots may be separately multiplied by a same OCC sequence or different OCC sequences. For example, an element in an OCC sequence may be multiplied by N slots. When one or more same RVs are repeatedly used in the N slots, and when Nₛₗₒₜₛ=2, two slots with a same RV are continuously repeated in every

$${N}_{slots} {N}_{identical}^{NPUSCH}$$

slots. In this scenario, a length L of the OCC sequence may be the same as

$${N}_{identical}^{NPUSCH} .$$

For example, for a slot-based OCC, an OCC sequence is only multiplied by each slot, and the slot includes or does not include a reference symbol.

For example, for an RV-based OCC, an element in an OCC sequence may be multiplied by a same RV or different RVs. Considering that an RV is cycled among slots/repetitions, an RV cyclic period needs to be aligned with a span of an OCC sequence, and description is provided below with reference to FIG. 7 and FIG. 8.

For example, an element in the first sequence W=[wᵢ(0), wᵢ(1), . . . wᵢ(m)] may be multiplied by a signal in time domain.

A related design and determination method of the first sequence corresponding to the first uplink channel are described above with reference to FIG. 4. The first sequence may be any one of a plurality of orthogonal sequences, and a plurality of devices including the first device may multiplex a same resource to perform uplink transmission. According to this method, a transmission mode and transmission resource of the first device may be considered to determine a length of the first sequence, so as to improve transmission efficiency.

Further, a method for transmitting the first uplink channel by the first device based on the first sequence is described in step S420 in FIG. 4. For example, data or a sequence obtained after spectrum spreading may be generated by using the first sequence and the first uplink channel, so as to transmit to-be-transmitted data of the first uplink channel. However, a length of the first sequence is determined based on a plurality of factors, for example, transmission information of the first uplink channel, and segment compensation that may be required for the first uplink channel. Therefore, how to combine the first sequence with the to-be-transmitted data of the first uplink channel to generate a reasonable spread-spectrum result is also a technical problem to be resolved. In other words, how to apply the first sequence to transmission of the first uplink channel is also a technical problem to be resolved.

For this problem, the result obtained after the spectrum spreading in embodiments of the present application may be further determined based on one or more of the following pieces of information: a transmission mode of the first uplink channel, a quantity of redundancy versions related to the first uplink channel; or whether to perform segment compensation on the first uplink channel.

In some embodiments, the result obtained after the spectrum spreading is determined based on the first sequence and one or more of the following pieces of information: a transmission mode of the first uplink channel, a quantity of redundancy versions related to the first uplink channel; or whether to perform segment compensation on the first uplink channel.

The following describes an association relationship between a spread-spectrum result and a transmission mode of the first uplink channel with reference to FIG. 5 and FIG. 6. The transmission mode of the first uplink channel may be related to a type of the first uplink channel. Different types of uplink channels may support different transmission modes.

In some embodiments, the transmission mode of the first uplink channel may include single frequency transmission, multiple frequency transmission, and/or information about a subcarrier spacing.

In an example, the result obtained after the spectrum spreading may be determined based on a subcarrier spacing.

In some embodiments, the transmission mode of the first uplink channel may be used to determine a cyclic period of the first sequence and/or a length of the first sequence.

In an example, different transmission modes may respectively correspond to different cyclic periods of the first sequence. The first device may determine the cyclic period of the first sequence based on the transmission mode of the first uplink channel. For example, for single frequency transmission of an NPUSCH, a cyclic period of the first sequence whose length is 4 may be

$$4 \cdot {N}_{slot}^{UL} \cdot {N}_{RU} .$$

$$4 \cdot {N}_{slot}^{UL} \cdot {N}_{RU}$$

In other words, the first sequence may be applied every slots. For another example, for multiple frequency transmission of the NPUSCH, the first sequence whose length is 4 may be repeatedly applied every

$${N}_{slots} {N}_{identical}^{NPUSCH}$$

slots.

In an example, different transmission modes may respectively correspond to different lengths of the first sequence. The first device may determine the length of the first sequence based on the transmission mode of the first uplink channel, so as to generate, based on the first sequence, the result obtained after the spectrum spreading. For example, for single frequency transmission of an NPUSCH, the length of the first sequence may be Nᵣₑₚ. For another example, for multiple frequency transmission of the NPUSCH, the length of the first sequence may be

$${N}_{identical}^{NPUSCH} .$$

To understand an association between the transmission mode and the result obtained after the spectrum spreading, example description is provided below with reference to a plurality of transmission modes.

Single frequency transmission of an NPUSCH is used as an example, and for single frequency transmission (where

$${N}_{sc}^{RU} = 1 ) , {N}_{identical}^{NPUSCH} = 1.$$

Spectrum spreading may be performed on modulated data of the NPUSCH by using the first sequence W=[wᵢ(0), wᵢ(1), . . . wᵢ(m)], to obtain a spread-spectrum result Z (a second sequence Z or data Z obtained after the spectrum spreading). When a subcarrier spacing is 3.75 kHz, the spread spectrum result Z may include

$$z ( {mN}_{TB} {N}_{RU} {N}_{slot}^{UL} + n ) : z ( {mN}_{TB} {N}_{RU} {N}_{slot}^{UL} + n ) = {w}_{i} ( m ) y ( n ) ,$$

$$n = 0 , 1 , ... , {N}_{TB} {N}_{slot}^{UL} {N}_{RU} - 1 , and m = 0 , 1 , ... , {N}_{rep} - 1 ,$$

where

N_{RU} represents a quantity of resource units, N_{TB} represents a quantity of TBs scheduled in unicast,

$${N}_{slot}^{UL}$$

represents a quantity of slots in one resource unit, Nᵣₑₚ represents a quantity of repetitions related to the first uplink channel, [wᵢ(0), wᵢ(1), . . . , wᵢ(m)] represents the first sequence, and y(n) represents a modulation signal of the first uplink channel.

Multiple frequency transmission of the NPUSCH is used as an example, and for multiple frequency transmission (where

$${N}_{sc}^{RU} > 1 ) , {N}_{identical}^{NPUSCH} = min ( ⌈ \frac{{N}_{rep}}{2} ⌉ , 4 ) .$$

Spectrum spreading may be performed on data of the NPUSCH by using the first sequence W=[wᵢ(0), wᵢ(1), . . . wᵢ(m)], to obtain a spread-spectrum result Z (a second sequence Z or data Z obtained after the spectrum spreading). When a subcarrier spacing of multiple frequency transmission is 15 kHz, the spread-spectrum result Z includes

$$z ( {mN}_{TB} {N}_{identical}^{NPUSCH} {N}_{RU} {N}_{slot}^{UL} + n ) : z ( {mN}_{TB} {N}_{identical}^{NPUSCH} {N}_{RU} {N}_{slot}^{UL} + n ) = {w}_{i} ( m ) y ( n ) ,$$

$$n = 0 , 1 , ... , {N}_{TB} {N}_{identical}^{NPUSCH} {N}_{RU} {N}_{slot}^{UL} - 1 , and m = 0 , 1 , ... , {N}_{identical}^{NPUSCH} - 1 ,$$

where

N_{RU} represents a quantity of resource units, N_{TB} represents a quantity of TBs scheduled in unicast,

$${N}_{slot}^{UL}$$

represents a quantity of slots in one resource unit,

$${N}_{identical}^{NPUSCH} = min ( ⌈ \frac{{N}_{rep}}{2} ⌉ , 4 ) ,$$

Nᵣₑₚ represents a quantity of repetitions related to the first uplink channel, [wᵢ(0), wᵢ(1), . . . , wᵢ(m)] represents the first sequence, and y(n) represents a modulation signal of the first uplink channel.

For ease of understanding a plurality of manners in which the first sequence is applied to the first uplink channel, an example in which the first uplink channel is in an NPUSCH format 1 and the first OCC sequence has a length of 4 is used, and example description is provided below with reference to single frequency transmission in FIG. 5 and multiple frequency transmission in FIG. 6.

Referring to FIG. 5, a subcarrier spacing is 3.75 kHz, and one RU includes 16 slots, that is,

$${N}_{slot}^{UL} = 16.$$

When a quantity of repetitions of the first uplink channel is four (Nᵣₑₚ=4), N_{RU} RUs (16N_{RU} slots) are repeated four times. Two redundancy versions (RV0 and RV2) corresponding to the first uplink channel are cycled in four repeated 16N_{RU} slots. RV0 corresponds to a first repetition and a third repetition, and RV2 corresponds to a second repetition and a fourth repetition.

As shown in FIG. 5, four elements OCC(0), OCC(1), OCC(2), and OCC(3) in the first OCC sequence separately correspond to N_{RU} RUs. When a quantity of repetitions of the first uplink channel is greater than four, the first OCC sequence is applied every 4×16N_{RU}=64N_{RU} slots.

Referring to FIG. 6, a subcarrier spacing is 15 kHz, and one RU includes two slots, that is,

$${N}_{slot}^{UL} = 2. When {N}_{rep} \geq 8 , {N}_{identical}^{NPUSCH} = min ( ⌈ \frac{{N}_{rep}}{2} ⌉ , 4 ) = 4.$$

### N_{identical} in FIG. 6 is

$${N}_{identical}^{NPUSCH} ,$$

and therefore, N_{identical} includes four RUs (eight slots).

As shown in FIG. 6, in time domain corresponding to N_{identical}, four elements OCC(0), OCC(1), OCC(2), and OCC(3) in the first OCC sequence correspond to four RUs. In N_{RU} RUs, the four elements in the first OOC sequence are repeatedly applied to

$${N}_{slot}^{UL} {N}_{identical}^{NPUSCH} = 8 slots .$$

A quantity of repetitions of the first OOC sequence may be N_{RU}/N_{identical}.

The association relationship between the spread-spectrum result and the transmission mode is described above with reference to FIG. 5 and FIG. 6. It may be learned from FIG. 5 that elements in the first sequence may be repeatedly applied to a plurality of redundancy versions. The following describes an association relationship between a spread-spectrum result and a redundancy version of the first uplink channel with reference to FIG. 7 and FIG. 8.

In some embodiments, the first uplink channel corresponds to a plurality of redundancy versions, for example, the first uplink channel corresponds to two redundancy versions. The plurality of redundancy versions corresponding to the first uplink channel are used for transmission of the first uplink channel. In an example, the result obtained after the spectrum spreading may be determined based on products of a plurality of redundancy versions and a plurality of elements in the first sequence.

In some embodiments, the result obtained after the spectrum spreading is related to a repetition manner of the plurality of redundancy versions. Certainly, regardless of a repetition manner of RV0 and RV2, an element in the first sequence is multiplied by a slot block of a plurality of consecutive slots with a same RV.

In an example, the plurality of redundancy versions of the first uplink channel may be cycled based on a particular period. Two redundancy versions (RV0 and RV1) are used as an example, and when a quantity of repetitions of the first uplink channel is greater than 2, RV0 and RV1 may be repeated in an interleaved mode. For example, when the quantity of repetitions is four, the repetitions of the two redundancy versions may be as shown in FIG. 5.

In an example, the plurality of redundancy versions of the first uplink channel may not be repeated in an interleaved mode, but transmitted in sequence. A quantity of repetitions of each redundancy version may be determined based on the quantity of repetitions of the first uplink channel. In actual communication, a redundancy version may be transmitted after transmission of another redundancy version is completed. Two redundancy versions (RV0 and RV1) are still used as an example, and when the quantity of repetitions is 4, RV0 and RV1 are each repeated twice. Therefore, four redundancy versions of the first uplink channel may be RV0, RV0, RV2, and RV2.

In some embodiments, regardless of whether the redundancy versions are transmitted in an interleaved and repeated manner or in sequence, adjacent redundancy versions are orthogonal to each other after being multiplied by the element in the first sequence. In other words, when two adjacent redundancy versions are the same, they may be differentiated by multiplying them with different elements, so as to ensure orthogonality. It should be noted that, when orthogonality of the plurality of redundancy versions is ensured, there is no need for all the plurality of redundancy versions of the first uplink channel to be multiplied by the elements in the first sequence.

In some embodiments, the plurality of redundancy versions include a first redundancy version and a second redundancy version, and the first sequence includes a first element and a second element. When the plurality of redundancy versions are cycled in a plurality of periods, the first redundancy version in the plurality of periods is multiplied by the first element, and the second redundancy version in the plurality of periods is multiplied by the second element.

In some embodiments, when the plurality of redundancy versions are cycled in a plurality of periods, each of the plurality of periods is multiplied by different elements in the first sequence. In this scenario, a quantity of elements in the first sequence is greater than or equal to a quantity of periods in which the redundancy versions are cycled.

In some embodiments, the plurality of redundancy versions include a plurality of adjacent first redundancy versions, two adjacent first redundancy versions are multiplied by different elements in the first sequence, respectively.

In an example, a same redundancy version may correspond to a same element. When the first sequence is an OCC sequence, a same OCC code sequence may be used for a same redundancy version. Two redundancy versions (RV0 and RV1) and the first sequence including two elements (W₀ and W₁) are still used as an example, a slot in RV0 is multiplied by an element 1 (W₀): all slots included in RV0 are multiplied by W₀; and a slot in RV2 is multiplied by an element 2 (W₁): all slots included in RV2 are multiplied by W₁.

In an example, a same redundancy version may correspond to different elements. When the first sequence is an OCC sequence, different OCC code sequences may be used for a same redundancy version. Two redundancy versions (RV0 and RV1) and the first sequence including two elements (W₀ and W₁) are still used as an example, example description is provided below with reference to FIG. 7 and FIG. 8. Each redundancy version in FIG. 7 and FIG. 8 includes eight slots.

Two redundancy versions in FIG. 7 are transmitted in sequence, and therefore, adjacent redundancy versions may be the same. As shown in FIG. 7, a slot in the first RV0 is multiplied by an element 1 (W₀): all slots included in the first RV0 are multiplied by W₀; and a slot in the second RV0 is multiplied by an element 2 (W₁): all slots included in the second RV0 are multiplied by W₁. Correspondingly, two RV2s are multiplied by the element 1 and the element 2, respectively.

Optionally, when the first sequence includes four elements (W₀, W₁, W₂, and W₃), a slot in the first RV2 in FIG. 7 may be multiplied by an element 3 (W₂): the element W₂ is multiplied by all slots included in the first RV2; and a slot in the second RV2 may be multiplied by an element 4 (W₃): the element W₃ is multiplied by all slots included in the second RV2.

Two redundancy versions in FIG. 8 are repeated in an interleaved mode, and therefore, adjacent redundancy versions are different. As shown in FIG. 8, slots in the first RV0 and the first RV2 are multiplied by an element 1 (W₀): all slots included in the first RV0 and the first RV2 are multiplied by W₀; and slots in the second RV0 and the second RV2 are multiplied by an element 2 (W₁): all slots included in the second RV0 and the second RV2 are multiplied by W₁.

An embodiment in which a spread-spectrum result is determined based on the first sequence and a plurality of redundancy versions is described above with reference to FIG. 7 and FIG. 8. It may be learned from the foregoing description that the spread-spectrum result may be further determined based on whether to perform segment compensation on the first uplink channel. In an internet of things-based NTN, a terminal device may pre-compensate for a delay/Doppler drift based on a location of the terminal device and a satellite location provided by ephemeris information. When segment compensation is performed on an uplink channel, time pre-compensation and frequency pre-compensation of each UL segment may be adjusted based on transmission duration provided by a higher layer parameter npusch-TxDuration-r17.

In some embodiments, when segment compensation is performed on the first uplink channel based on a plurality of segments, the result obtained after the spectrum spreading may be determined based on products of the plurality of segments and different elements in the first sequence. In an example, the first sequence may be an orthogonal OCC sequence used for compensating for a delay/Doppler drift based on an NPUSCH segment.

In an example, each of the plurality of segments on which segment compensation is performed may be separately multiplied by one OCC codeword.

In an example, one of the plurality of segments may be divided into several groups, and each group is multiplied by a different OCC codeword.

In some embodiments, phase continuity may not be ensured when new pre-compensation begins, and therefore, orthogonal sequences need to be applied to different UL segments, so that orthogonality can be ensured. If a UL segment is too large or a relative velocity of a satellite is high, the UL segment may change due to a change in the delay and/or Doppler shift, and therefore, the UL segment needs to be set based on a specific principle.

In an example, when the first uplink channel is transmitted by using a satellite, a time length of a plurality of segments may be determined based on one or more of the following pieces of information: a type of the satellite; transmission duration of the first uplink channel; whether the first device moves; or a timing error or a phase error related to the satellite. The time length of the plurality of segments may also be referred to as a segment length.

For example, the plurality of segments of the first uplink channel may vary depending on types of serving satellites. For example, a GEO satellite, a LEO satellite, and a MEO satellite may separately correspond to different segmentation manners. Different types of satellites may correspond to different heights, and therefore, a type of a satellite may also be represented as a relative distance between the first device and the satellite. When segmentation is performed based on a slot, a higher altitude of a satellite causes a longer transmission delay time, and therefore, a time length of the plurality of segments is longer.

For example, the plurality of segments of the first uplink channel may be determined based on transmission duration. For example, segmentation is performed based on a time length provided by npusch-TxDuration-r17.

For example, the plurality of segments of the first uplink channel may be determined based on whether the first device moves. Whether the first device moves is related to a path loss of the first device at different locations. In other words, segmentation may be performed for segment compensation of the first uplink channel based on path loss estimation. Sizes of the plurality of segments may be fixed or adjusted dynamically. For example, a fixed UL segment may be used for the first device with a fixed location, and a variable UL segment may be used for the first device of a mobile type.

For example, the plurality of segments of the first uplink channel may be determined based on a timing error or a phase error related to the satellite. In an internet of things-based NTN, a network device (for example, a base station) may calculate a timing error, a Doppler shift change, and a phase error of the first device, so as to provide a time length of a plurality of segments that may be obtained based on UL segment compensation. For example, the base station may calculate a timing error, a Doppler shift change, and a phase error of a reference point in a beam, so as to provide segment length configuration of segment pre-compensation.

In an example, a time length of a plurality of segments is determined based on a reference point, and the reference point is a point with a smallest satellite elevation angle in a cell. Because a beam radius of a low earth orbit satellite is generally less than a satellite height (for example, a satellite beam radius of LEO-1200 km Set-1 is generally 45 km), segment length configuration obtained through calculation based on the reference point is not obviously different from a maximum segment length of another terminal having a same capability in the cell. To avoid a situation in which the timing error or the phase error exceeds a limit when the first device adopts the segment length, the selected reference point may be a point with the smallest satellite elevation angle in the cell. It is assumed that both an elevation angle of the reference point relative to the satellite and an elevation angle of the base station relative to the satellite are 30 degrees, the reference point has a timing error of 12 time units (Ts) after timing adjustment. When pre-compensation or post-compensation is not considered for a delay and a phase, a change amount of the Doppler shift is about 1 Hz/20 ms, which causes little impact, and an error limit may not be exceeded for at least 32 slots, and therefore, the change may be negligible. In addition, the delay drift is about 70.8 ppm, a phase error caused by the delay drift is ΔØ=70.8 nm/ms×180 kHz×360=4.59 degrees/ms, and at most six slots are maintained without exceeding a phase continuity limit. Therefore, the base station may configure six slots as the time length of the plurality of segments.

Association relationships between the spread-spectrum result and the transmission mode, the redundancy version, and segment compensation are separately described above. It may be learned from the foregoing description that a slot in which the first uplink channel is located may include a DMRS. When the slot includes the DMRS, how to multiplex the DMRS is a technical problem to be resolved.

In some embodiments, when a transmission resource corresponding to the first uplink channel includes a DMRS, a same orthogonal sequence as that of the first uplink channel may be used for the DMRS. In an example, the DMRS may be processed by using the first sequence. In other words, spectrum spreading processing may be performed on the DMRS by using the first sequence, which is the same as that of other data in the slot. For example, a same OCC codeword may be used for both a DMRS of an NPUSCH and a symbol occupied for transmitting NPUSCH data.

In some embodiments, when a transmission resource corresponding to the first uplink channel includes a DMRS, an orthogonal sequence different from that of the first uplink channel may be used for the DMRS. In other words, the DMRS may be processed by using other sequences different from the first sequence. For example, different OCC codewords may be used for a DMRS of an NPUSCH and a symbol occupied for transmitting NPUSCH data.

In some embodiments, when a time-frequency resource on which the first uplink channel is located has only one DMRS and a plurality of users want to multiplex the same resource, the same DMRS symbol cannot be multiplexed. For example, each slot in an NPUSCH format 1 has one DMRS. In particular, for single frequency transmission, one slot has only one DMRS in time domain and frequency domain.

To resolve the problem, there is no need to process the DMRS by using the first sequence that is the same as that of the first uplink channel. To support more user transmission on a same time and frequency resource, a second sequence corresponding to the DMRS may be determined based on one or more random seeds. The second sequence may be a DMRS sequence. Optionally, the second sequence is a pseudorandom sequence generated after a random seed is applied to a time domain OCC.

In an example, the second sequence is a second OCC sequence. The first OCC sequence is the same as or different from the second OCC sequence.

In some embodiments, the one or more random seeds include a first random seed, and the first random seed is related to an identity (identity, ID) of a cell in which the first device is located. For example, for single frequency transmission, an NPUSCH DMRS sequence (the second sequence) is a pseudorandom sequence generated after a random seed that is determined based on an NB-IoT cell ID is applied to a time domain OCC. Because a time domain OCC is already used for cell randomization, and an OCC index is determined based on the NB-IoT cell ID, for a given cell, a single OCC index is used in a period of time. For single frequency transmission, an additional time domain OCC and/or additional random seed used for sequence generation may increase a multiplexing capacity of a DMRS sequence.

In an example, the second sequence is determined based on a plurality of random seeds, and the plurality of random seeds further include a second random seed. The second sequence may be determined based on a first random sequence that is generated based on the first random seed and a second random sequence that is generated based on the second random seed. The first random seed may be referred to as an original random seed, and the second random seed may be an introduced extra random seed.

For example, it is assumed that the original random seed is S_{id} (generated based on the NB-IoT cell ID) and the extra random seed is Sₑₓₜᵣₐ. The DMRS sequence (the second sequence) may be generated based on the two random seeds. The second sequence may be determined based on an original DMRS sequence that is generated based on S_{id} and an extra DMRS sequence that is generated based on Sₑₓₜᵣₐ.

In an example, assuming that a generation function of the second sequence is f(s), the original DMRS sequence may be represented as D_{id}=f(S_{id}), that is, the first random sequence; and the extra DMRS sequence may be represented as Dₑₓₜᵣₐ=f(Sₑₓₜᵣₐ), that is, the second random sequence. More DMRS sequences may be obtained after the original DMRS sequence D_{id} is combined with the extra DMRS sequence Dₑₓₜᵣₐ, so that diversity of DMRS sequences is increased.

Optionally, the second sequence may include the first random sequence and the second random sequence. For example, simple addition (the second sequence D=D_{id}+Dₑₓₜᵣₐ) or exclusive OR processing may be performed on the original DMRS sequence and the extra DMRS sequence.

Optionally, the second sequence may be obtained after the two sequences are mixed together based on a specific proportion. In other words, the second sequence may be determined based on a first weight. According to this method, contribution degrees of two different DMRS sequences to a final DMRS sequence may be controlled. For example, the second sequence may be represented as: D(i)=∂D_{id}(i)+(1−∂)Dₑₓₜᵣₐ(i);

where i may represent an index, and ∂ represents the first weight, where a value range of the first weight is between 0 and 1.

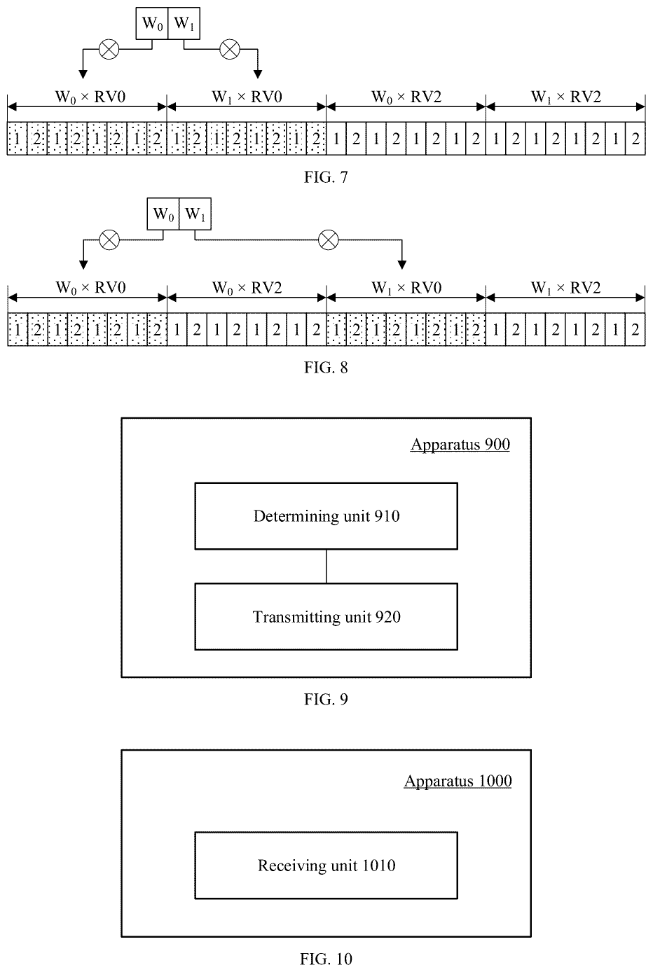

Method embodiments of the present application are described above in detail with reference to FIG. 1 to FIG. 8. Apparatus embodiments of the present application are described below in detail with reference to FIG. 9 to FIG. 11. It should be understood that description of the apparatus embodiments corresponds to description of the method embodiments. Therefore, for parts that are not described in detail, reference may be made to the foregoing method embodiments.

FIG. 9 is a schematic block diagram of an apparatus for wireless communication according to an embodiment of the present application. The apparatus 900 may be any one of the first devices described above. The first device may include a terminal device. The apparatus 900 shown in FIG. 9 includes a determining unit 910 and a transmitting unit 920.

The determining unit 910 may be configured to determine a first sequence corresponding to a first uplink channel. The first sequence is a sequence in a first sequence set, the first sequence set includes a plurality of mutually orthogonal sequences, and the plurality of sequences are determined based on a plurality of time domain units in a first time domain unit group.

The transmitting unit 920 may be configured to transmit the first uplink channel based on the first sequence.

Optionally, the first device is one of a plurality of devices, and a plurality of uplink channels respectively corresponding to the plurality of devices multiplex the plurality of time domain units by using the first sequence set.

Optionally, the first time domain unit group is one of a plurality of time domain unit groups, the plurality of time domain unit groups respectively correspond to a plurality of different time domain unit lengths, and the plurality of different time domain unit lengths are used to determine the first time domain unit group in the plurality of time domain unit groups.

Optionally, the plurality of time domain unit groups are determined based on a plurality of grouping manners of a first time resource, the first time resource is used to transmit the plurality of uplink channels, and the plurality of grouping manners are determined based on a part of or all of the following time lengths: all slots in different redundancy versions; all slots in one redundancy version; some slots in one redundancy version; all slots in one resource unit; one slot; or one or more symbols in one slot.

Optionally, grouping information of the plurality of time domain unit groups includes levels of the plurality of time domain unit groups, and the grouping information is carried in DCI or an SIB.

Optionally, a quantity of the plurality of sequences is equal to a quantity of devices multiplexing the plurality of time domain units.

Optionally, the first device is one of the plurality of devices, the first device transmits the first uplink channel at a first instant based on the first sequence, the first time domain unit group is determined based on a plurality of feedbacks transmitted by the plurality of devices at a second instant earlier than the first instant, and the second instant is adjacent to the first instant.

Optionally, if a quantity of NACKs in the plurality of feedbacks is greater than or equal to a first threshold, a time domain unit length of the first time domain unit group is less than a time domain unit length of a third time domain unit group, and the third time domain unit group is associated with a feedback transmitted by the first device at the second instant.

Optionally, a length of the first sequence is determined based on a quantity of time domain units in the first time domain unit group and/or a quantity of repetitions of the first uplink channel.

Optionally, the length of the first sequence is equal to the quantity of time domain units in the first time domain unit group, or the length of the first sequence is equal to the quantity of repetitions of the first uplink channel.

Optionally, to-be-transmitted data of the first uplink channel is transmitted after spectrum spreading is performed on the data by using the first sequence, and a result obtained after the spectrum spreading is further determined based on one or more of the following pieces of information: a transmission mode of the first uplink channel; a quantity of redundancy versions related to the first uplink channel; or whether to perform segment compensation on the first uplink channel.

Optionally, the first uplink channel is an NPUSCH, and a transmission mode of the first uplink channel is used to determine the length of the first sequence and/or a cyclic period of the first sequence.

Optionally, the transmission mode of the first uplink channel is single frequency transmission, and the result obtained after the spectrum spreading includes

$$z ( {mN}_{TB} {N}_{RU} {N}_{slot}^{UL} + n ) : z ( {mN}_{TB} {N}_{RU} {N}_{slot}^{UL} + n ) = {w}_{i} ( m ) y ( n ) , \\ n = 0 , 1 , ... , {N}_{TB} {N}_{slot}^{UL} {N}_{RU} - 1 , and m = 0 , 1 , ... , {N}_{rep} - 1 ,$$

where

N_{RU} represents a quantity of resource units, N_{TB} represents a quantity of TBs scheduled in unicast,

$${N}_{slot}^{UL}$$

represents a quantity of slots in one resource unit, Nᵣₑₚ represents a quantity of repetitions related to the first uplink channel, [wᵢ(0), wᵢ(1), . . . , wᵢ(m)] represents the first sequence, and y(n) represents a modulation signal of the first uplink channel.

Optionally, the transmission mode of the first uplink channel is multiple frequency transmission, and the result obtained after the spectrum spreading includes

$$z ( {mN}_{TB} {N}_{identical}^{NPUSCH} {N}_{R U} {N}_{slot}^{UL} + n ) : z ( m {N}_{TB} {N}_{identical}^{NPUSCH} {N}_{R U} {N}_{slot}^{UL} + n ) = {w}_{i} ( m ) y ( n ) ,$$

$$n = 0 , 1 , … , {N}_{T B} {N}_{identical}^{NPUSCH} {N}_{R U} {N}_{slot}^{UL} - 1 , and m = 0 , 1 , … , {N}_{identical}^{NPUSCH} - 1 ,$$

where

N_{RU} represents a quantity of resource units, N_{TB} represents a quantity of TBs scheduled in unicast,

$${N}_{slot}^{U L}$$

represents a quantity of slots in one resource unit,

$${N}_{identical}^{NPUSCH} = min ( ⌈ \frac{{N}_{rep}}{2} ⌉ , 4 ) ,$$

Nᵣₑₚ represents a quantity of repetitions related to the first uplink channel, [wᵢ(0), wᵢ(1), . . . , wᵢ(m)] represents the first sequence, and y(n) represents a modulation signal of the first uplink channel.

Optionally, the first uplink channel corresponds to a plurality of redundancy versions, and the result obtained after the spectrum spreading is determined based on products of the plurality of redundancy versions and a plurality of elements in the first sequence.

Optionally, when segment compensation is performed on the first uplink channel based on a plurality of segments, the result obtained after the spectrum spreading is determined based on products of the plurality of segments and different elements in the first sequence.

Optionally, the first uplink channel is transmitted by using a satellite in a non-terrestrial network, and a time length of the plurality of segments is determined based on one or more of the following pieces of information: a type of the satellite; transmission duration of the first uplink channel; whether the first device moves; or a timing error or a phase error related to the satellite.

Optionally, a transmission resource corresponding to the first uplink channel includes a DMRS, a second sequence corresponding to the DMRS is determined based on one or more random seeds, the one or more random seeds include a first random seed, and the first random seed is related to an ID of a cell in which the first device is located.

Optionally, the second sequence is a second OCC sequence, the second sequence is determined based on a plurality of random seeds, the plurality of random seeds further include a second random seed, and the second sequence is determined based on a first random sequence that is generated based on the first random seed and a second random sequence that is generated based on the second random seed.

Optionally, the plurality of sequences are a group of OCC sequences, and the first sequence is a first OCC sequence.

FIG. 10 is a schematic block diagram of another apparatus for wireless communication according to an embodiment of the present application. The apparatus 1000 may be any one of the second devices described above. The second device may include a network device. The apparatus 1000 shown in FIG. 10 includes a receiving unit 1010.

The receiving unit 1010 may be configured to receive a first uplink channel that is transmitted by a first device based on a first sequence. The first uplink channel corresponds to the first sequence, the first sequence is a sequence in a first sequence set, the first sequence set includes a plurality of mutually orthogonal sequences, and the plurality of sequences are determined based on a plurality of time domain units in a first time domain unit group.

Optionally, the first device is one of a plurality of devices, and a plurality of uplink channels respectively corresponding to the plurality of devices multiplex the plurality of time domain units by using the first sequence set.

Optionally, the first time domain unit group is one of a plurality of time domain unit groups, the plurality of time domain unit groups respectively correspond to a plurality of different time domain unit lengths, and the plurality of different time domain unit lengths are used to determine the first time domain unit group in the plurality of time domain unit groups.

Optionally, the plurality of time domain unit groups are determined based on a plurality of grouping manners of a first time resource, the first time resource is used to transmit the plurality of uplink channels, and the plurality of grouping manners are determined based on a part of or all of the following time lengths: all slots in different redundancy versions; all slots in one redundancy version; some slots in one redundancy version; all slots in one resource unit; one slot; or one or more symbols in one slot.

Optionally, grouping information of the plurality of time domain unit groups includes levels of the plurality of time domain unit groups, and the grouping information is carried in DCI or an SIB.

Optionally, a quantity of the plurality of sequences is equal to a quantity of devices multiplexing the plurality of time domain units.

Optionally, the first device is one of the plurality of devices, the first device transmits the first uplink channel at a first instant based on the first sequence, the first time domain unit group is determined based on a plurality of feedbacks transmitted by the plurality of devices at a second instant earlier than the first instant, and the second instant is adjacent to the first instant.

Optionally, if a quantity of NACKs in the plurality of feedbacks is greater than or equal to a first threshold, a time domain unit length of the first time domain unit group is less than a time domain unit length of a third time domain unit group, and the third time domain unit group is associated with a feedback transmitted by the first device at the second instant.

Optionally, a length of the first sequence is determined based on a quantity of time domain units in the first time domain unit group and/or a quantity of repetitions of the first uplink channel.

Optionally, the length of the first sequence is equal to the quantity of time domain units in the first time domain unit group, or the length of the first sequence is equal to the quantity of repetitions of the first uplink channel.

Optionally, to-be-transmitted data of the first uplink channel is transmitted after spectrum spreading is performed on the data by using the first sequence, and a result obtained after the spectrum spreading is further determined based on one or more of the following pieces of information: a transmission mode of the first uplink channel; a quantity of redundancy versions related to the first uplink channel; or whether to perform segment compensation on the first uplink channel.

Optionally, the first uplink channel is an NPUSCH, and a transmission mode of the first uplink channel is used to determine the length of the first sequence and/or a cyclic period of the first sequence.

Optionally, the transmission mode of the first uplink channel is single frequency transmission, and the result obtained after the spectrum spreading includes

$$z ( m {N}_{T B} {N}_{R U} {N}_{slot}^{UL} + n ) : z ( m {N}_{TB} {N}_{R U} {N}_{slot}^{UL} + n ) = {w}_{i} \cdot ( m ) y ( n ) , n = 0 , 1 , … , {N}_{TB} {N}_{slot}^{UL} {N}_{R U} - 1 , and m = 0 , 1 , … , {N}_{rep} - 1 ,$$

where

N_{RU} represents a quantity of resource units, N_{TB} represents a quantity of TBs scheduled in unicast,

$${N}_{slot}^{UL}$$

represents a quantity of slots in one resource unit, Nᵣₑₚ represents a quantity of repetitions related to the first uplink channel, [wᵢ(0), wᵢ(1), . . . , wᵢ(m)] represents the first sequence, and y(n) represents a modulation signal of the first uplink channel.

Optionally, the transmission mode of the first uplink channel is multiple frequency transmission, and the result obtained after the spectrum spreading includes

$$z ( {mN}_{TB} {N}_{identical}^{NPUSCH} {N}_{R U} {N}_{slot}^{UL} + n ) : z ( m {N}_{TB} {N}_{identical}^{NPUSCH} {N}_{R U} {N}_{slot}^{UL} + n ) = {w}_{i} ( m ) y ( n ) ,$$

$$n = 0 , 1 , … , {N}_{T B} {N}_{identical}^{NPUSCH} {N}_{R U} {N}_{slot}^{UL} - 1 , and m = 0 , 1 , … , {N}_{identical}^{NPUSCH} - 1 ,$$

where

N_{RU} represents a quantity of resource units, N_{TB} represents a quantity of TBs scheduled in unicast,

$${N}_{slot}^{UL}$$

represents a quantity of slots in one resource unit,

$${N}_{identical}^{NPUSCH} = min ( ⌈ \frac{{N}_{rep}}{2} ⌉ , 4 ) ,$$

Nᵣₑₚ represents a quantity of repetitions related to the first uplink channel, [wᵢ(0), wᵢ(1), . . . , wᵢ(m)] represents the first sequence, and y(n) represents a modulation signal of the first uplink channel.

Optionally, the first uplink channel corresponds to a plurality of redundancy versions, and the result obtained after the spectrum spreading is determined based on products of the plurality of redundancy versions and a plurality of elements in the first sequence.

Optionally, when segment compensation is performed on the first uplink channel based on a plurality of segments, the result obtained after the spectrum spreading is determined based on products of the plurality of segments and different elements in the first sequence.

Optionally, the first uplink channel is transmitted by using a satellite in a non-terrestrial network, and a time length of the plurality of segments is determined based on one or more of the following pieces of information: a type of the satellite; transmission duration of the first uplink channel; whether the first device moves; or a timing error or a phase error related to the satellite.

Optionally, a transmission resource corresponding to the first uplink channel includes a DMRS, a second sequence corresponding to the DMRS is determined based on one or more random seeds, the one or more random seeds include a first random seed, and the first random seed is related to an ID of a cell in which the first device is located.

Optionally, the second sequence is a second OCC sequence, the second sequence is determined based on a plurality of random seeds, the plurality of random seeds further include a second random seed, and the second sequence is determined based on a first random sequence that is generated based on the first random seed and a second random sequence that is generated based on the second random seed.

Optionally, the plurality of sequences are a group of OCC sequences, and the first sequence is a first OCC sequence.

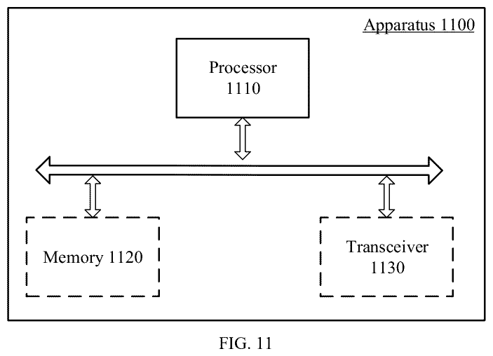

FIG. 11 is a schematic structural diagram of a communications apparatus according to an embodiment of the present application. Dashed lines in FIG. 11 indicate that a unit or module is optional. The apparatus 1100 may be configured to implement the method described in the foregoing method embodiments. The apparatus 1100 may be a chip, a terminal device, or a network device.

The apparatus 1100 may include one or more processors 1110. The processor 1110 may support the apparatus 1100 in implementing the method described in the foregoing method embodiments. The processor 1110 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1100 may further include one or more memories 1120. The memory 1120 stores a program, and the program may be executed by the processor 1110, so that the processor 1110 executes the method described in the foregoing method embodiments. The memory 1120 may be separate from the processor 1110 or may be integrated into the processor 1110.

The apparatus 1100 may further include a transceiver 1130. The processor 1110 may communicate with another device or chip by using the transceiver 1130. For example, the processor 1110 may transmit data to and receive data from another device or chip by using the transceiver 1130.

An embodiment of the present application further provides a computer-readable storage medium for storing a program. The computer-readable storage medium may be applied to a terminal device or a network device provided in embodiments of the present application, and the program causes a computer to execute a method executed by the terminal device or the network device in various embodiments of the present application.

The computer-readable storage medium may be any usable medium accessible by a computer, or a data storage device such as a server or a data center that integrates one or more available media. The usable medium may be a magnetic medium (for example, a floppy disk, a hard disk, or a magnetic tape), an optical medium (for example, a digital video disc (digital video disc, DVD)), a semiconductor medium (for example, a solid state disk (solid state disk, SSD)), or the like.

An embodiment of the present application further provides a computer program product. The computer program product includes a program. The computer program product may be applied to a terminal device or a network device provided in embodiments of the present application, and the program causes a computer to execute a method executed by the terminal device or the network device in various embodiments of the present application.

All or some of the foregoing embodiments may be implemented by using software, hardware, firmware, or any combination thereof. When the software is used to implement embodiments, all or some of the embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner.

An embodiment of the present application further provides a computer program. The computer program may be applied to a terminal device or a network device provided in embodiments of the present application, and the computer program causes a computer to execute a method executed by the terminal or the network device in various embodiments of the present application.

The terms “system” and “network” in the present application may be used interchangeably. In addition, the terms used in the present application are merely used to explain the specific embodiments of the present application, and are not intended to limit the present application. In the specification, claims, and accompanying drawings of the present application, the terms “first”, “second”, “third”, “fourth”, and the like are intended to distinguish between different objects but do not describe a particular order. In addition, the terms “include” and “have” and any variations thereof are intended to cover a non-exclusive inclusion.

In embodiments of the present application, “indicate” mentioned herein may be a direct indication, or may be an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, the term “corresponding” may mean that there is a direct or indirect correspondence between two elements, or that there is an association relationship between two elements, or that there is a relationship of “indicating” and “being indicated”, “configuring” and “being configured”, or the like.

In embodiments of the present application, “pre-defining” or “pre-configuring” may be implemented by pre-storing corresponding codes, tables, or other forms that may be used to indicate related information in devices (for example, including a terminal device and a network device). A specific implementation thereof is not limited in the present application. For example, being pre-defined may refer to being defined in a protocol.

In embodiments of the present application, determining B based on A does not mean determining B based on only A, but instead B may be determined based on A and/or other information.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between associated objects.

In embodiments of the present application, sequence numbers of the foregoing processes do not mean execution orders. The execution orders of the processes should be determined based on functions and internal logic of the processes, and should not be construed as any limitation on implementation processes of embodiments of the present application.

In several embodiments provided in the present application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. Indirect couplings or communication connections between apparatuses or units may be implemented in electrical, mechanical, or other forms.

The units described as separate parts may be or may not be physically separate, and parts displayed as units may be or may not be physical units, and may be at one location, or may be distributed on a plurality of network elements. Some or all of the units may be selected based on actual requirements to achieve the objective of the solutions of the embodiments.

In addition, functional units in embodiments of the present application may be integrated into one processing unit, or each of the units may exist alone physically, or two or more units may be integrated into one unit.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A method for wireless communication, comprising:
obtaining, by a first device, a first sequence corresponding to a first uplink channel; and
transmitting, by the first device, the first uplink channel based on the first sequence; wherein
the first sequence is a sequence in a first sequence set, the first sequence set comprises a plurality of mutually orthogonal sequences, and the plurality of sequences corresponding to a plurality of time domain units in a first time domain unit group.

2. The method according to claim 1, wherein the first device is one of a plurality of devices, and a plurality of uplink channels respectively corresponding to the plurality of devices that are multiplexed in the plurality of time domain units by using the first sequence set.

3. The method according to claim 2, wherein the first time domain unit group is one of a plurality of time domain unit groups, the plurality of time domain unit groups respectively correspond to a plurality of different time domain unit lengths, and the plurality of different time domain unit lengths are used to determine the first time domain unit group in the plurality of time domain unit groups.

4. The method according to claim 3, wherein the plurality of time domain unit groups are determined based on a plurality of grouping manners of a first time resource, the first time resource is used to transmit the plurality of uplink channels, and the plurality of grouping manners are determined based on a part of or all of the following time lengths:
all slots in different redundancy versions;
all slots in one redundancy version;
some slots in one redundancy version;
all slots in one resource unit;
one slot; or
one or more symbols in one slot.

5. The method according to claim 3, wherein grouping information of the plurality of time domain unit groups comprises levels of the plurality of time domain unit groups, and the grouping information is carried in downlink control information (DCI) or a system information block (SIB).

6. The method according to claim 1, wherein a quantity of the plurality of sequences is equal to a quantity of devices multiplexing the plurality of time domain units.

7. The method according to claim 1, wherein the first device is one of a plurality of devices, the first device transmits the first uplink channel at a first instant based on the first sequence, the first time domain unit group is determined based on a plurality of feedbacks transmitted by the plurality of devices at a second instant earlier than the first instant, and the second instant is adjacent to the first instant.

8. The method according to claim 7, wherein when a quantity of negative acknowledgements (NACKs) in the plurality of feedbacks is greater than or equal to a first threshold, a time domain unit length of the first time domain unit group is less than a time domain unit length of a third time domain unit group, and the third time domain unit group is associated with a feedback transmitted by the first device at the second instant.

9. The method according to claim 1, wherein a length of the first sequence corresponding to at least one of a quantity of time domain units in the first time domain unit group or a quantity of repetitions of the first uplink channel.

10. The method according to claim 9, wherein the length of the first sequence is equal to the quantity of time domain units in the first time domain unit group, or the length of the first sequence is equal to the quantity of repetitions of the first uplink channel.

11. The method according to claim 1, wherein to-be-transmitted data of the first uplink channel is transmitted after spectrum spreading is performed on the data by using the first sequence, and a result obtained after the spectrum spreading is further determined based on one or more of the following pieces of information:
a transmission mode of the first uplink channel;
a quantity of redundancy versions related to the first uplink channel; or
whether to perform segment compensation on the first uplink channel.

12. The method according to claim 11, wherein the first uplink channel is a narrow band physical uplink shared channel (NPUSCH), and the transmission mode of the first uplink channel is used to determine at least one of a length of the first sequence or a cyclic period of the first sequence.

13. The method according to claim 12, wherein the transmission mode of the first uplink channel is single frequency transmission, and the result obtained after the spectrum spreading comprises
$$z ( m {N}_{T B} {N}_{R U} {N}_{slot}^{UL} + n ) : z ( m {N}_{TB} {N}_{R U} {N}_{slot}^{UL} + n ) = {w}_{i} \cdot ( m ) y ( n ) ,$$
$$n = 0 , 1 , … , {N}_{TB} {N}_{slot}^{UL} {N}_{R U} - 1 , and m = 0 , 1 , … , {N}_{rep} - 1 ,$$
wherein
N_{RU} represents a quantity of resource units, N_{TB} represents a quantity of transport blocks TBs scheduled in unicast,
$${N}_{slot}^{UL}$$
represents a quantity of slots in one resource unit, Nᵣₑₚ represents a quantity of repetitions related to the first uplink channel, [wᵢ(0), wᵢ(1), . . . , wᵢ(m)] represents the first sequence, and y(n) represents a modulation signal of the first uplink channel.

14. The method according to claim 12, wherein the transmission mode of the first uplink channel is multiple frequency transmission, and the result obtained after the spectrum spreading comprises
$$z ( {mN}_{TB} {N}_{identical}^{NPUSCH} {N}_{R U} {N}_{slot}^{UL} + n ) : z ( m {N}_{TB} {N}_{identical}^{NPUSCH} {N}_{R U} {N}_{slot}^{UL} + n ) = {w}_{i} ( m ) y ( n ) ,$$
$$n = 0 , 1 , … , {N}_{T B} {N}_{identical}^{NPUSCH} {N}_{R U} {N}_{slot}^{UL} - 1 , and m = 0 , 1 , … , {N}_{identical}^{NPUSCH} - 1 ,$$
wherein
N_{RU} represents a quantity of resource units, N_{TB} is a quantity of TBs scheduled in unicast,
$${N}_{slot}^{UL}$$
represents a quantity of slots in one resource unit,
$${N}_{identical}^{NPUSCH} = min ( ⌈ \frac{{N}_{rep}}{2} ⌉ , 4 ) ,$$
Nᵣₑₚ represents a quantity of repetitions related to the first uplink channel, [wᵢ(0), wᵢ(1), . . . , wᵢ(m)] represents the first sequence, and y(n) represents a modulation signal of the first uplink channel.

15. The method according to claim 11, wherein the first uplink channel corresponds to a plurality of redundancy versions, and the result obtained after the spectrum spreading is determined based on products of the plurality of redundancy versions and a plurality of elements in the first sequence.

16. The method according to claim 11, wherein when segment compensation is performed on the first uplink channel based on a plurality of segments, the result obtained after the spectrum spreading is determined based on products of the plurality of segments and different elements in the first sequence.

17. The method according to claim 16, wherein the first uplink channel is transmitted by using a satellite in a non-terrestrial network, and a time length of the plurality of segments is determined based on one or more of the following pieces of information:
a type of the satellite;
transmission duration of the first uplink channel;
whether the first device moves; or
a timing error or a phase error related to the satellite.

18. The method according to claim 1, wherein a transmission resource corresponding to the first uplink channel comprises a demodulation reference signal (DMRS), a second sequence corresponding to the DMRS is determined based on one or more random seeds, the one or more random seeds comprise a first random seed, and the first random seed is related to an identity (ID) of a cell in which the first device is located, wherein the second sequence is a second orthogonal cover code (OCC) sequence, the second sequence is determined based on a plurality of random seeds, the plurality of random seeds further comprise a second random seed, and the second sequence is determined based on a first random sequence that is generated based on the first random seed and a second random sequence that is generated based on the second random seed.

19. The method according to claim 1, wherein the plurality of sequences are a group of OCC sequences, and the first sequence is a first OCC sequence.

20. A method for wireless communication, comprising:
receiving, by a second device and from a first device, a first uplink channel based on a first sequence; wherein
the first uplink channel corresponds to the first sequence, the first sequence is a sequence in a first sequence set, the first sequence set comprises a plurality of mutually orthogonal sequences, and the plurality of sequences are determined based on a plurality of time domain units in a first time domain unit group.
